(19) United States
(12) Patent Application Publication
(10) Pub. No.: US 2013/0065596 A1
(43) Pub. Date: Mar. 14, 2013

(54) METHOD AND APPARATUS FOR CONTROLLING HANDOVER AND RESELECTION

(71) Applicants: Frank Frederiksen, Klarup (DK); Jeroen Wigard, Klarup (DK); Lars Dalsgaard, Oulu (FI); Troels Emil Kolding, Klarup (DK)

(72) Inventors: Frank Frederiksen, Klarup (DK); Jeroen Wigard, Klarup (DK); Lars Dalsgaard, Oulu (FI); Troels Emil Kolding, Klarup (DK)

(73) Assignee: Nokia Siemens Networks OY, Espoo (FI)

(21) Appl. No.: 13/699,429

(22) PCT Filed: May 25, 2010
(86) PCT No.: PCT/EP10/57154

§ 371 Date: Nov. 21, 2012

(51) Int. Cl. H04W 36/24

(52) U.S. Cl. 455/436

(57) ABSTRACT

A method and an apparatus for controlling handover and reselection are provided. The apparatus comprises: a controller configured to obtain information related to the energy consumption of one or more services on one or more systems utilizing different radio access technology; and determine a need for a handover or a reselection for a mobile unit using one or more services on the basis of the information.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context. In the past, a number of wireless radio access technologies have been standardized. These include GSM (Global System for Mobile communication), UMTS (Universal Mobile Telecommunications System), and LTE (Long Term Evolution), for example. As technology advances further systems are being continuously developed and standardized.

One typical feature in the development of new radio access technologies is that as new techniques and services are developed, the supported data rates increase. On the other hand, the power consumption of devices supporting the new techniques and services tends to increase. The power consumption of an active service depends on the required Quality of Service (QoS) and the network technology. Although with advanced battery technology is possible to produce efficient batteries there is a need to manage the power usage of mobile devices.

### BRIEF DESCRIPTION

According to an aspect of the present invention, there is provided an apparatus comprising: a controller configured to obtain information related to the energy consumption of one or more services on one or more systems utilizing different radio access technology; and determine a need for a handover or a reselection for a mobile unit using one or more services on the basis of the information.

According to another aspect of the present invention, there is provided a method comprising: obtaining information related to the energy consumption of one or more services on one or more systems utilizing different radio access technology; and determining a need for a handover or a reselection for a mobile unit using one or more services on the basis of the information.

According to another aspect of the present invention, there is provided an apparatus comprising: at least one processor; and at least one memory including a computer program code, wherein the at least one memory and the computer program code are configured, with the at least one processor, to cause the apparatus to: obtain information related to the energy consumption of one or more services on one or more systems utilizing different radio access technology; and determine a need for a handover or a reselection for a mobile unit using one or more services on the basis of the information.

According to another aspect of the present invention, there is provided an apparatus comprising: means for obtaining information related to the energy consumption of one or more services on one or more systems utilizing different radio access technology; and means for determining a need for a handover or a reselection for a mobile unit using one or more services on the basis of the information.

### LIST OF DRAWINGS

Embodiments of the present invention are described below, by way of example only, with reference to the accompanying drawings, in which

FIG. 1 illustrates a general architecture of a communication system;

FIGS. 2A and 2B are flow charts illustrating embodiments of the invention; and

FIGS. 3A and 3B illustrate examples of apparatuses according to embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Typically, modern mobile devices provide options for being connected to multiple radio systems. For example, most modern devices are capable of GSM and UMTS dual mode operation. Many present and future devices from different mobile vendors support even more wireless radio access technology standards, such as LTE-A (LTE-Advanced), WLAN (Wireless local area network), WiMAX (Worldwide interoperability for microwave access), and the like.

Different radio access technologies may offer different services. The services may lead to different power consumption of a mobile device. The power consumption may depend on the service and the access technology. The same service may be more power consuming in a system employing a given RAT and more power efficient in a system employing another RAT. Some access technologies are by nature more power consuming compared to others. Ideally, the energy consumption for each radio access technology would scale linearly with the potential, offered data rate. However, given that different systems are designed differently (with different sleep/wake modes, power conservation and probing mechanisms, for example), power consumption by a mobile device does not necessarily scale linearly with data rate. For example, a given mobile phone may be able to connect to networks using different radio access technologies, such as GSM, Wideband Code Division Multiple Access (WCDMA), High-Speed Downlink Packet Access (HSDPA), Unlicensed Mobile Access (UMA), and WLAN. In this example, using WLAN may drain the mobile phone more quickly than the other radio access technologies. On the other hand, the same phone controlled to operate only in GSM mode as the radio access technology will drain the least power, when compared to these other radio access technologies—having thus a higher stand-by time. In short, depending on which radio access technology is used, the power consumption of the user equipment and thus the corresponding standby time will vary accordingly.

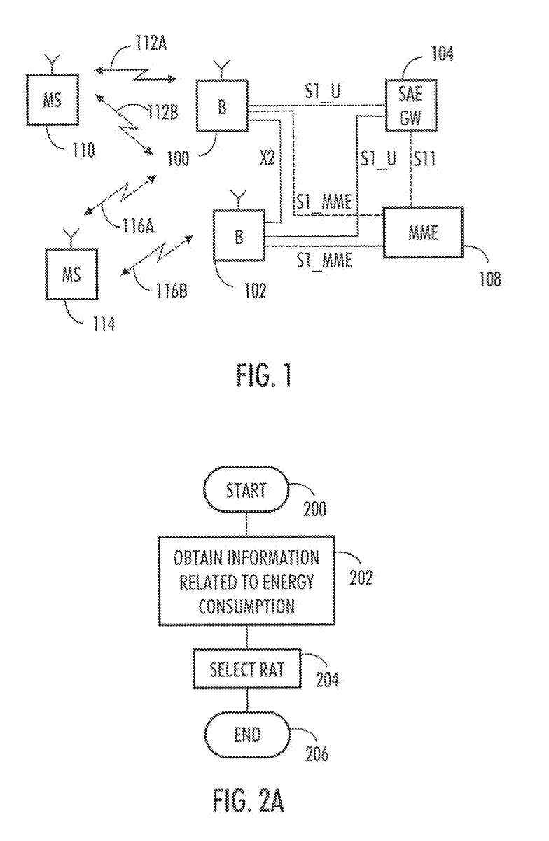

Moreover, in some implementations, a mobile device may operate over multiple radio access technologies simultaneously by monitoring, for example, GSM, UTRAN, E-UTRAN, UMA, Bluetooth, and other connections (e.g., the user equipment continuously measures the different radio access technologies in order to be connected to an optimum network at any given time). As such, the energy consumption typically increases with the number of radio access networks supported by the user equipment and the higher data rates/bandwidth of these networks. With reference to FIG. 1, let us examine an example of a communication system to which embodiments of the invention can be applied. In this example, the core network of the communication system is based on LTE network elements. However, the invention described in these examples is not limited to the LTE network but can be implemented in systems utilizing various radio access technologies such as GSM, LTA-E, WLAN, WiMAX and others mentioned above, for example.

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements, and protocols used in or for group communication are irrelevant to the actual invention. Therefore, they need not be discussed in more detail here.

The exemplary radio system of FIG. 1 comprises a service core of an operator including the following elements: an MME (Mobility Management Entity) 108 and an SAE GW (SAE Gateway) 104.

Base stations of the system may also be called eNBs (Enhanced node Bs, eNodeBs) 100, 102. In an embodiment, the eNBs of the system host the functions for Radio Resource Management: Radio Bearer Control, Radio Admission Control, Connection Mobility Control, Dynamic Resource Allocation (scheduling). In an embodiment, the system may comprise other network elements hosting at least part of respective functions. The MME 108 is responsible for distributing paging messages to the eNodeBs 100, 102. The eNodeBs are connected to the SAE GW with an S1_U interface and to MME with an S1_MME interface. The eNodeBs may be connected to each other with X2 interface. FIG. 1 shows mobile apparatuses 110 and 114 located in the service area of the eNodeBs 100, 102. A mobile apparatus refers to a portable computing device. Such computing devices include wireless mobile communication devices operating with or without a subscriber identification module (SIM), including, but not limited to, the following types of devices: mobile phone, smartphone, personal digital assistant (PDA), handset, laptop computer. The apparatus may be battery powered.

In the example situation of FIG. 1, the mobile apparatus 110 has a connection 112A with the eNodeB 100. The connection 112A may be a bidirectional connection related to a speech call or a data service such as browsing the Internet 110. In addition, the apparatus 110 may have a control connection 112B with the eNodeB 102. In this example, the mobile apparatus 114 has control connections 116A, 116B to the eNodeBs 110, 102. In a control connection, an eNodeB is aware of the mobile apparatus may be able to transfer control information between the apparatus but an active traffic connection does not exist.

FIG. 1 only illustrates a simplified example. In practice, the network may include more base stations and radio network controllers, and more cells may be formed by the base stations. The networks of two or more operators may overlap, the sizes and form of the cells may vary from what is depicted in FIG. 1, etc.

It should be appreciated that the communication system may also comprise other core network elements besides SAE GW 104 and MME 108. In addition, the core network may be realized with different network elements altogether. Direct communication between different eNodeBs over an air interface is also possible by implementing a relay node concept, wherein a relay node may be considered as a special eNodeB having wireless backhauls or, for instance, X2 and S1 interfaces relayed over the air interface by another eNodeB. The communication system is also able to communicate with other networks, such as a public switched telephone network.

The embodiments are not, however, restricted to the network given above as an example, but a person skilled in the art may apply the solution to other communication networks provided with the necessary properties. For example, the connections between different network elements may be realized with Internet Protocol (IP) connections.

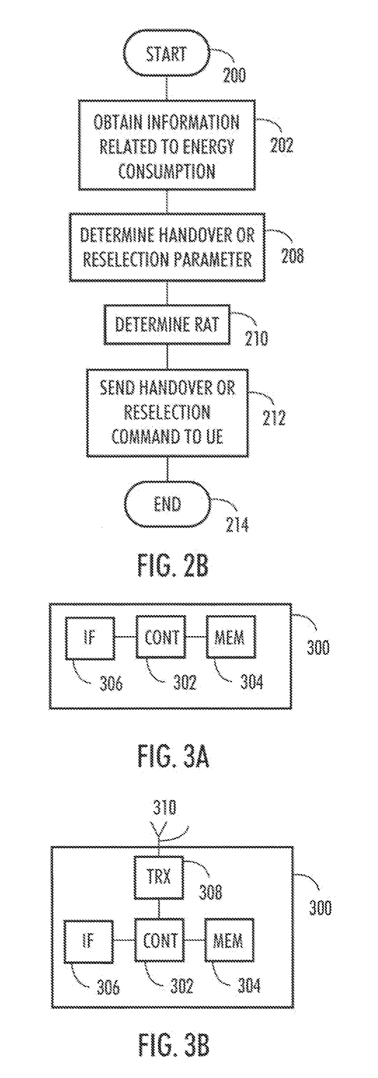

In an embodiment, the eNodeBs 100, 102 may utilize different radio access technologies. For example, the eNodeB 100 may be a GSM or UTRA base station and the eNodeB 102 may be WLAN or WiMAX base station. In an embodiment, an eNodeB may be configured to support more than one radio access technology. FIG. 2A is a flowchart illustrating an embodiment of the invention. The embodiment starts at step 200.

In step 202, a controller of a network apparatus obtains information related to the energy consumption of one or more services on one or more systems utilizing different radio access technology. In an embodiment, the network apparatus is an eNodeB, for example the eNodeB 100.

In an embodiment, the network apparatus or an eNodeB obtains information about the cost in energy per received and transmitted bit for given services available in the area served by the network apparatus. A service can for instance be characterized by Quality of Service Class Identifier (QCI) in LTE or by traffic class and traffic handling priority in 3G.

The information may be obtained in various ways. The information related to the energy consumption may be requested from one or more mobile apparatuses. The network apparatus, such as the eNodeB 100, may send a request message to a mobile apparatus, for example to the mobile apparatus 110. The request message indicates to the mobile apparatus 110 to report its energy consumption under the current radio access technology being used by the mobile apparatus 110 to communicate (i.e., at least one of transmit or receive). For example, a radio resource control message may be used to carry the request message, although other mechanisms may be used as well. For example, rather than using control the control plane signaling of radio resource control, user plane messages may be used as well to carry the request message. In an embodiment, the mobile apparatuses may autonomously report the information without any special request from network.

The mobile apparatus 110 may determine its energy consumption. In some implementations, the mobile apparatus 110 may determine the energy consumption of the radio access technology being used in terms of energy per bit for that given radio access technology. The mobile apparatus 110 can typically determine the transmitted power per bit via measurement, monitoring or other suitable methods known in the art. The mobile apparatus 110 reports to the network apparatus the determined energy consumption. The network apparatus may receive a message, such as a radio resource control message, although user plane messages may be used as well to carry the report message.

In an embodiment, the network apparatus, such as the eNodeB 100, may determine energy consumption. For example, the eNodeB 100 may determine the energy consumption of the downlink to the mobile apparatus 110 based on the power transmitted by the eNodeB 100 to the mobile apparatus for a given radio access technology. For example, when the eNodeB 100 is transmitting via a GSM/UTRA/WLAN downlink to mobile apparatus 110, the eNodeB 110 may determine the power consumption (e.g., energy per bit of power transmitted via the downlink to the mobile apparatus 110).

In an embodiment, the network apparatus, such as the eNodeB 100, may receive energy consumption information from other network apparatuses. The information may have been determined on the basis of statistical information, for example.

In step 204, the network apparatus determines a need for a handover or a reselection for a mobile apparatus using one or more services on the basis of the take the information. Thus, the network apparatus may select a radio access technology to a connection between a mobile apparatus and an eNodeB from the technologies available to the devices on the basis of the service.

The embodiment ends at step 206.

FIG. 2B is another flowchart illustrating an embodiment of the invention. The embodiment starts at step 200.

The step 202 is the same as in connection with FIG. 2A. The controller of a network apparatus obtains information related to the energy consumption of one or more services on one or more systems utilizing different radio access technology.

In step 208, the controller of a network apparatus determines a handover or reselection parameter on the basis of the information.

In an embodiment, the network apparatus or an eNodeB is configured to modify hysteresis value of a handover algorithm on the basis of the information.

In an embodiment, the network apparatus or an eNodeB is configured to modify a threshold value of a handover algorithm on the basis of the information.

In step 210, the network apparatus determines a need for a handover or a reselection for a mobile apparatus using one or more services on the basis of the take the information. The information about the energy cost may be included as separate threshold or hysteresis value in handover or reselection process in order to adjust the trade-off between energy efficiency and number of handovers.

In step 212, the network apparatus sends a handover or reselection command to the mobile apparatus. If the RAT selected in step 210 was the same as the RAT the mobile apparatus is camping on, this step may be omitted.

The embodiment ends at step 214.

Following example illustrates an embodiment. Let us assume two mobile apparatuses UE1 and UE2, which are both connected to an eNodeB using High-Speed Packet Access (HSPA). UE1 starts a voice call, while UE2 performs a file download. The eNodeB obtains or stores following costs for voice per bit (the numeric values are only examples of possible values):

TABLE 1

| | | Browsing |
|---|---|---|
| Rat | Speech service | (file download) |
| GSM | 4 J per second | 400 J per 100 kB file |
| | speech | |
| HSPA | 8 J per second | 60 J per 100 kB file |
| | speech | |
| LTE | 6 J per second | 30 J per 100 kB file |
| | speech | |

An example of a normal hysteresis based Power BudGet Handover (PBGT) is PBGT=H−(PL(candidate cell j)−PL(serving cell)),

where H is the hysteresis, PL(candidate cell j) is the path loss from a mobile apparatus to the candidate cell j and PL(serving cell) is the path loss from a mobile apparatus to the serving cell.

A handover is triggered when PBGT becomes equal or lower than zero.

It is to be noted that even though the sites of different RATs are co-sited, the path loss may be different since the carrier frequency may be different.

In an embodiment, the hysteresis value can be modified to take the information related to the energy consumption into account. As the mobile apparatuses UE1 and UE2 are using HSPA we can focus on the hysteresis coming from HSPA:

Hysteresis for speech (coming from HSPA) to GSM may be defined as H−x1 dB and hysteresis for speech (coming from HSPA) to LTE may be defined as H−x2 dB, where x2<x1 and both x1 and x2 are larger than zero dB. Given the example energy consumption values of Table 1, the following values illustrate values that can be used for x1 and x2:

x1=H, since voice is twice as cheap on GSM as on HSPA energy wise (8 J vs. 4 J per second of speech).
x2=½H, since voice is 25% cheaper on LTE as on HSPA energy wise (6 J vs. 4 J per second of speech).

Larger x1 and x2 values will lead to more energy savings. Hysteresis for file download (coming from HSPA) to GSM may be defined as H−y1 dB and hysteresis for file download (coming from HSPA) to LTE may be defined as H−y2 dB, where y2>y1 and y1<0 dB while y2>0 dB. Given the example energy consumption values of Table 1, the following values illustrate example values that can be used for y1 and y2:

y1=−2H, since data is almost 7 times more expensive on GSM as on HSPA energy wise (60 J vs. 400 J per 100 kB).
y2=H, since data is twice as cheap on LTE as on HSPA energy wise (60 J vs. 30 J per 100 kB file download).

By tuning the x1, x2, y1 and y2 parameters, the trade-off between the number of handovers and energy savings can be adjusted.

In an embodiment, separate handover triggers may be introduced or existing triggers modified in an eNodeB. In addition, existing mobility triggers, like a coverage based or a service based handover can be combined with the embodiments presented here.

FIG. 3A illustrates an example of a network apparatus 300 according to an embodiment of the invention. The apparatus 300 comprises a controller 302 and a memory 304 operationally connected to the controller. The controller 302 controls the operation of the apparatus. The memory 304 is configured to store software and data. The controller is configured to obtain information related to the energy consumption of one or more services on one or more systems utilizing different radio access technology; and determine a need for a handover or a reselection for a mobile unit using one or more services on the basis of the take the information. The memory 304 may be configured to store information related to the energy consumption of one or more service on one or more systems utilizing different radio access technology. In an embodiment, the controller is configured to obtain the cost related information from the memory. In an embodiment, the controller is further configured to request cost information from one or more mobile units. In an embodiment, the controller is further configured to modify hysteresis or threshold value of a handover or a reselection algorithm on the basis of the information.

In an embodiment, the controller is further configured to weight the system with the smallest energy consumption on the basis of the information when determining a need for an intersystem handover for a mobile unit.

The network apparatus 300 may be operationally connected to other network apparatuses of a communication system. The other network apparatus may be an MME (Mobility Management Entity), an SAE GW (SAE Gateway), a radio network controller (RNC), a base station, a gateway, or a server, for example. The network apparatus 300 may be connected to more than one network apparatus. The network apparatus 300 may comprise an interface 306 configured to set up and maintain connections with the other network apparatuses.

In an embodiment, the apparatus 300 is a base station or an eNodeB. FIG. 3B illustrates this embodiment. The apparatus 300 may further comprise a transceiver 308 operationally connected to the controller 302. The transceiver 308 is configured to set up and maintain a wireless connection to mobile apparatuses within the service area of base station or eNodeB. The transceiver 308 is operationally connected to an antenna arrangement 310. The antenna arrangement may comprise a set of antennas. The number of antennas may be two to four, for example. The number of antennas is not limited to any particular number.

The apparatus 300 may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides an article of manufacture comprising a computer readable medium and embodying program instructions thereon executable by a computer operably coupled to a memory which, when executed by the computer, perform the at least the steps of obtaining information related to the energy consumption of one or more services on one or more systems utilizing different radio access technology; and determining a need for a handover or a reselection for a mobile unit using one or more services on the basis of the take the information.

The computer program may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital computer or it may be distributed amongst a number of computers.

The steps/points, and related functions described above are in no absolute chronological order, and some of the steps/points may be performed simultaneously or in an order differing from the given one. Other functions can also be executed between the steps/points or within the steps/points. Some of the steps/points or part of the steps/points can also be left out or replaced by a corresponding step/point or part of the step/point.

It will be obvious to a person skilled in the art that, as technology advances, the inventive concept can be implemented in various ways. The invention and its embodiments are not limited to the examples described above but may vary within the scope of the claims.

1. An apparatus, comprising:
a controller;
a memory operationally connected to the controller,
wherein the controller and the memory are configured to
obtain information related to energy consumption of one or more services on one or more systems utilizing different radio access technology; and
determine a need for a handover or a reselection for a mobile unit using one or more services based upon the information.

2. The apparatus of claim 1, wherein the memory is configured to store information related to the energy consumption of one or more services on one or more systems utilizing different radio access technology.

3. The apparatus of claim 1, wherein the controller is further configured to receive information related to energy consumption from one or more mobile units.

4. The apparatus of claim 1, wherein the controller is further configured to request information related to energy consumption from one or more mobile units.

5. The apparatus of claim 1, wherein the controller is further configured to modify a hysteresis value of a handover or a reselection algorithm based upon the information.

6. The apparatus of claim 1, wherein the controller is further configured to modify a threshold value of a handover or a reselection algorithm based upon the information.

7. The apparatus of claim 1, wherein the controller is further configured to weight the system with the smallest energy consumption based upon the information when determining a need for an intersystem handover for a mobile unit.

8. A method, comprising:
obtaining information related to energy consumption of one or more services on one or more systems utilizing different radio access technology; and
determining a need for a handover or a reselection for a mobile unit using one or more services based upon the information.

9. The method of claim 8, further comprising:
storing information related to the energy consumption of one or more services on one or more systems utilizing different radio access technology.

10. The method of claim 8, further comprising:
receiving information related to energy consumption from one or more mobile units.

11. The method of claim 8, further comprising:
requesting information related to energy consumption from one or more mobile units.

12. The method of claim 8, further comprising:
modifying a hysteresis value of a handover or a reselection algorithm based upon the information.

13. The method of claim 8, further comprising:
modifying a threshold value of a handover or a reselection algorithm based upon the information.

14. The method of claim 8, further comprising:
weighting the system with the smallest energy consumption based upon the information when determining a need for an intersystem handover for a mobile unit.

15. A chipset, said chipset comprising the apparatus of claim 1.

16. A computer program embodied on a non-transitory computer-readable medium, said computer program comprising program code which, when the program is run on a computer, controls the computer to perform the method of claim 8.

17. An article of manufacture comprising a non-transitory computer readable medium, and embodying program instructions thereon executable by a computer operably coupled to a memory which, when executed by the computer, perform the steps of claim 8.

18. (canceled)

19. (canceled)

20. The apparatus according to claim 1, wherein the apparatus comprises a base station or a nodeB.

21. A method, comprising:
determining, by a mobile apparatus, energy consumption under a current radio access technology being used by the mobile apparatus to communicate; and
reporting the energy consumption to a network apparatus.

22. The method according to claim 21, wherein the reporting is performed in response to receiving a request message from the network apparatus.

23. A computer program embodied on a non-transitory computer-readable medium, the program comprising computer code which, when run on a processor, controls the processor to perform the method of claim 21.

24. The method according to claim 21, wherein the energy consumption is determined in terms of energy per bit for the current radio access technology.

25. The method of claim 21, wherein the reporting comprises reporting via a radio resource control message or a user plane message.

26. An apparatus, comprising:
a controller;
a memory operationally connected to the controller,
wherein the controller and the memory are configured to determine energy consumption of the apparatus under a current radio access technology being used to communicate; and
report the energy consumption to a network apparatus.

27. The apparatus of claim 26, wherein the controller and the memory are further configured to report the energy consumption in response to a request from the network apparatus.

28. The apparatus according to claim 26, wherein the controller and the memory are further configured to determine the energy consumption in terms of energy per bit for the current radio access technology.

29. The apparatus of claim 26, wherein the controller and memory are configured to report the energy consumption via a radio resource control message or a user plane message.

30. The apparatus of claim 26, wherein the apparatus comprises a mobile apparatus.
